(19) United States
(12) Patent Application Publication
(10) Pub. No.: US 2007/0219300 A1
(43) Pub. Date: Sep. 20, 2007

(54) Curable rubber mix containing silica

(75) Inventor: Raffaele Di Ronza, Roma (IT)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, TOKYO (JP)

(21) Appl. No.: 11/711,065

(22) Filed: Feb. 27, 2007

(30) Foreign Application Priority Data
Feb. 27, 2006 (IT) TO2006A000139

(51) Int. Cl. C08K 5/05

(52) U.S. Cl. 524/386; 524/493

(57) ABSTRACT

A curable rubber mix having a cross-linkable unsaturated-chain polymer base; a curing system; and a reinforcing filler system having at least 50% by weight of silica; the reinforcing filler system has a polyether-polyol compound of formula I, with a molecular weight of 200 to 400;
CR(R′)₃ I where:
R is H or CH₂(OCH₂CH₂)ₙOH, where n is 1 to 3; and
each R′ is CH₂(OCH₂CH₂)ₙOH, where n is 1 to 3.

The present invention relates to a curable rubber mix containing silica, for producing tyres. More specifically, the present invention relates to a mix for producing tread compounds.

### BACKGROUND OF THE INVENTION

Here and hereinafter:

the term “silica” is intended to mean a silicon dioxide-based reinforcing agent;

the term “cross-linkable unsaturated-chain polymer base” is intended to mean any natural or synthetic non-cross-linked polymer capable of assuming all the chemical-physical and mechanical characteristics typically assumed by elastomers when cross-linked (cured) with sulphur-based systems; and

the term “polyether-polyol compound” is intended to mean a polymer comprising a number of ether groups and hydroxyl groups.

In the making of tyre tread compound mixes, reinforcing fillers are used, in which carbon black has been partly or entirely replaced with inorganic reinforcing agents such as chalk, talc, kaolin, bentonite, titanium dioxide, silicates of various types, and, above all, silica, to minimize the rolling resistance of the tyre.

Mixes containing silica as the reinforcing agent pose processing problems, on account of the relatively high viscosity of the mix.

Such problems are further emphasized in the case of mixes for producing passenger car tyre tread compounds, which normally contain a large amount of silica (at least 50% by weight of the total amount of reinforcing filler).

To counteract the silica-induced increase in viscosity, silica “activating” compounds—whose structure comprises a number of ether groups and hydroxyl groups, and which are referred to hereinafter as polyether-polyol compounds—are known to be added to the mix. Despite improvements in terms of the viscosity of the mix, and therefore ease of processing, silica-activating compounds also have the drawback of possibly modifying other properties of the mix, such as the Storage Dynamic modulus.

### SUMMARY OF THE INVENTION

It is an object of the present invention to provide a curable, silica-containing rubber mix, which is relatively easy to process, but without modifying other properties of the mix.

### DETAILED DESCRIPTION OF THE INVENTION

According to the present invention, there is provided a curable rubber mix comprising a cross-linkable unsaturated-chain polymer base; a curing system; and a reinforcing filler system comprising at least 50% by weight of silica; said curable rubber mix being characterized in that said reinforcing filler system comprises a polyether-polyol compound of formula I, with a molecular weight of 200 to 400;
CR(R′)₃ I

where:
R is H or CH₂(OCH₂CH₂)ₙOH, where n is 1 to 3; and
each R′ is CH₂(OCH₂CH₂)ₙOH, where n is 1 to 3.

R in the compound is preferably H.

The molecular weight is preferably 250 to 350.

The mix preferably contains 1 to 5 parts by weight, and more preferably 1.5 to 2.5 parts by weight, of polyether-polyol compound per 100 parts of polymer base.

Further characteristics of the present invention will be made clear in the following description of a number of purely non-limiting examples.

### EXAMPLES

Below are described examples of a mix (mix A) produced in accordance with the teachings of the present invention; a first comparison mix (mix B) containing no polyether-polyol compound; a second and third comparison mix (mix C and mix D) containing two respective polyether-polyol compounds not of formula I.

The example mixes described are produced as described below:

—Mix Preparation—

(1st Mixing Step)

Prior to commencing the mixing operation, a 237-270-litre tangential mixer is loaded with the cross-linkable polymer base, carbon black, silica, a silane bonding agent, zinc oxide, stearic acid, wax, antioxidants, and the polyether-polyol compound, to a fill factor of 66-72%.

The mixer is operated at a speed of 40-60 rpm, and the resulting mix is dumped reaching a temperature of 140-160° C.

(2nd Mixing Step)

The mix from the preceding step is mixed again in a mixer operated at a speed of 40-60 rpm, and is then dumped reaching a temperature of 130-150° C.

(3rd Mixing Step)

The curing system is added to the mix from the preceding step, to reach a fill factor of 63-67%.

The mixer is operated at a speed of 20-40 rpm, and the resulting mix is dumped reaching a temperature of 100-110° C.

—Mix Composition—

Table I shows the compositions of the mixes produced using the method described above. The component quantities are expressed in parts by weight per 100 parts of total polymer base.

TABLE I

| | Mix A | Mix B | Mix C | Mix D |
|---|---|---|---|---|
| SBR | 80 | 80 | 80 | 80 |
| Polybutadiene | 20 | 20 | 20 | 20 |
| Silica | 70 | 70 | 70 | 70 |
| Carbon black | 10 | 10 | 10 | 10 |
| Silane bonding | 7 | 7 | 7 | 7 |
| agent | | | | |
| Stearic acid | 2 | 2 | 2 | 2 |
| Zinc oxide | 2.5 | 2.5 | 2.5 | 2.5 |
| Antioxidant | 3 | 3 | 3 | 3 |
| Wax | 1.5 | 1.5 | 1.5 | 1.5 |
| Sulphur | 1.75 | 1.75 | 1.75 | 1.75 |
| Accelerators | 3.0 | 3.5 | 3.0 | 3.0 |
| Polyether-polyol | 2 | 0 | 2 | 2 |
| compound | | | | |

The polyether-polyol compound used in mix A is of formula CH (CH₂(OCH₂CH₂)₂OH)₃.

The polyether-polyol compounds used in mixes C and D have structures of other than formula I as it is described below:
the polyether-polyol compound of mix C is of formula CH (CH₂(OCH(CH₃)CH₂)₂OH)₃; and
the polyether-polyol compound of mix D is of formula RCHCHR, where R is CH₂OCH₂CH(CH₃)OCH₂C(CH₃)(OH).

—Laboratory Test Results of Mixes A, B, C, D—

The resulting mixes were tested to determine the values of various particularly significant parameters of each mix.

Table II shows the results of each parameter for each mix.

The parameters considered are the following:

viscosity (ML1′+4′ at 130° C.), measured in accordance with ASTM standard D1646;

rheometric values (t′10, t′90), measured in accordance with ASTM standard D2084;

physical property values (ultimate elongation EB %, fracture strength TB, modulus M100% and M300% values), measured in accordance with ASTM standard D412C; and

Storage Dynamic modulus (E′), measured in accordance with ASTM standard D5992.

The values in Table II refer to value 100 of mix B.

TABLE II

| | MIX A | MIX B | MIX C | MIX D |
|---|---|---|---|---|
| ML1′ + 4′ at 130° C. | 85 | 100 | 87 | 87 |
| t′10 | 100 | 100 | 100 | 85 |
| t′90 | 100 | 100 | 90 | 90 |
| TB | 102 | 100 | 102 | 101 |
| EB(%) | 100 | 100 | 100 | 97 |
| M100% | 101 | 100 | 101 | 101 |
| M300% | 100 | 100 | 102 | 102 |
| E′ at 30° C. | 100 | 100 | 80 | 85 |

As shown in Table II, mix A according to the invention has a much better viscosity value than mix B containing no polyether-polyol compound, while at the same time having a better Storage Dynamic modulus value than mixes C and D.

Though particularly significant, the other parameters in Table II are not commented on, by not varying to a great extent with respect to the comparison examples.

In short, curable rubber mixes comprising the polyether-polyol compound of formula I may be said to have better viscosity, while at the same time having no negative effect on the other parameters of the mix.

1) A curable rubber mix comprising a cross-linkable unsaturated-chain polymer base; a curing system; and a reinforcing filler system comprising at least 50% by weight of silica; said curable rubber mix being characterized in that said reinforcing filler system comprises a polyether-polyol compound of formula I, with a molecular weight of 200 to 400;
CR(R′)₃ I
where:
R is H or CH₂(OCH₂CH₂)ₙOH, where n is 1 to 3; and
each R′ is CH₂(OCH₂CH₂)ₙOH, where n is 1 to 3.

2) A mix as claimed in claim 1, wherein R is H.

3) A mix as claimed in claim 2, wherein n is 2.

4) A mix as claimed in claim 2, wherein the molecular weight of the compound of formula I is 250 to 350.

5) A mix as claimed in claim 1, wherein the compound of formula I is present in the amount of 1 to 5 parts by weight per 100 parts of polymer base.

6) A mix as claimed in claim 5, wherein the compound of formula I is present in the amount of 1.5 to 2.5 parts by weight per 100 parts of polymer base.

7) A tread, characterized by being made from a mix as claimed in claim 1.

8) A tyre, characterized by comprising a tread as claimed in claim 7.

9) Use of the polyether-polyol compound of formula I in curable rubber mixes for producing tyres;
CR(R′)₃ I
where:
R is H or CH₂(OCH₂CH₂)ₙOH, where n is 1 to 3; and
each R′ is CH₂(OCH₂CH₂)ₙOH, where n is 1 to 3.

10) Use of the polyether-polyol compound of formula I as claimed in claim 9, wherein R is H.

11) Use of the polyether-polyol compound of formula I as claimed in claim 10, wherein n is 2

12) Use of the polyether-polyol compound of formula I as claimed in claim 10, wherein the molecular weight is 250 to 350.
